(19) United States
(12) Patent Application Publication
(10) Pub. No.: US 2014/0026171 A1
(43) Pub. Date: Jan. 23, 2014

(54) METHOD OF DETERMINING AN UNUSUAL BEHAVIOUR OF AN ELECTRONIC APPARATUS, AND ELECTRONIC APPARATUS ABLE TO IMPLEMENT SUCH A METHOD

(71) Applicant: Thomas Landais, Rueil-Malmaison (FR)

(72) Inventor: Thomas Landais, Rueil-Malmaison (FR)

(73) Assignee: SAGEMCOM BROADBAND SAS, Rueil-Malmaison (FR)

(21) Appl. No.: 14/009,651

(22) PCT Filed: Mar. 30, 2012
(86) PCT No.: PCT/EP2012/055850

§ 371 Date: Oct. 3, 2013

(30) Foreign Application Priority Data
Apr. 4, 2011 (FR) 1152890

(51) Int. Cl. H04N 21/254

(52) U.S. Cl. CPC H04N 21/254
USPC 725/87

(57) ABSTRACT

A method of determining an unusual behaviour of an electronic apparatus, the electronic apparatus carrying out an operation requiring the use of an item of information regarding an internal reference clock of the electronic apparatus, the method including comparing the internal reference clock information item with a span of temporal coherence of the electronic apparatus, the span of temporal coherence being determined on the basis of various temporal information items stored within the electronic apparatus; in the case of inconsistency between the internal reference clock information item and the coherence span, storing an information item relating to an unusual behaviour of the electronic apparatus.

### TECHNICAL FIELD OF THE INVENTION

The present invention relates to a method of determining an unusual behaviour of an electronic apparatus, from time bases available within the considered electronic apparatus; it also relates to any electronic apparatus able to implement such a method. Such a detection of unusual use may intervene for example to determine user profiles that could be suspected of a fraudulent use of their electronic apparatus.

The field of the invention is generally speaking that of electronic apparatuses that can be connected to different sources able to transmit to the considered electronic apparatus a flux of information items, each source being associated with a time reference that is specific to it. As examples of such electronic apparatuses, digital radio receivers connected to the radio broadcasting digital network and/or connected to the Internet network may be cited. Digital tablets may also be cited, by means of which it is possible connect to the Internet network for example with a view to renting video on demand (VOD) films, which constitutes a first source with a first time reference, and by means of which it is possible to connect digital television adaptors, which constitutes a second source with a second time reference. As an example, digital television decoders, or set top boxes (STB) may also be cited.

The invention will be more particularly described within the context of digital television decoders, without the scope of the invention being restricted to this application example. Recent digital television decoders are capable of receiving fluxes of signals from different sources (terrestrial and/or satellite and/or cable and/or Internet, etc.).

In the field of digital television, digital television decoders are used, particularly in order to access a series of television channels which are transmitted encrypted and which are decrypted within the decoder. Television decoders are interface organs between television signal transmission systems, particularly digital television signals in MPEG and DVB format, and viewing monitors. The transmission means that transmit the television broadcasts to these decoders/receivers are either conventional aerial transmission means, or coaxial or optical cables, or rebroadcasting satellites that cover a region, or instead the Internet network. The decoder comprises receiving means to receive the transmitted signals and formatting means to transform the signals received into signals applicable directly on the controls of the display device.

Formatting is carried out by respecting parameter tables for each of the images to represent. Different types of tables may be distinguished: IS (Information System) tables, PSI (Programme Specific Information) tables, NIT (Network Information Tables), EIT (Event Information Tables), PAT (Programme Association Tables), CAT (Control Access Tables) or instead PMT (Programme Map Tables), etc.

### TECHNOLOGICAL BACKGROUND OF THE INVENTION

Once the tables have been constituted, it is indispensable for the correct operation of the decoder that it acquires an internal reference clock. The acquisition is carried out by recovering the clock information item most often via the source constituted of the flux of signals received by the decoder. Once the clock information item has been received, it constitutes the internal reference clock of the decoder, while being advantageously updated from time to time by the same source as that which had allowed its initial acquisition.

Such a reference clock is used permanently in decoding operations, but also in ancillary operations such as for example the purchase of video on demand (VOD). It makes it possible in particular to limit the use of VOD, once it is purchased, to a certain duration limited in time, usually by comparing the internal reference clock of the decoder with a clock information item that is available on a remote server. Certain persons guilty of fraud manage however to intervene on the internal reference clock of the decoder in order to bypass the security of VOD, consisting in limiting the viewing thereof to a limited time. It thus appears in this precise case of modifying the principle of the internal reference clock such as it has existed until now.

In a more general manner, for various applications of digital television decoders, and particularly for applications for controlling the correct operation of said decoders, it henceforth appears insufficient, the reference clock information item having become fundamental in the operation of the digital television decoder, to limit oneself to the normal operation until now; this consisted in storing a unique clock information item acquired via a unique source to determine said internal reference clock information item of the decoder.

### GENERAL DESCRIPTION OF THE INVENTION

The subject matter of the invention offers a solution to the problems that have been described by proposing a method of generating a time base within a digital television decoder in which a plurality of clock information items coming from different sources are used in order to constitute said considered time base. Thus, each digital television decoder is capable of having a temporal behaviour that is specific to it, behaviour defined by the distributor of the decoder and/or by different clock information items which are available via different sources. Advantageously, the present invention proposes recovering clock information items coming from at least one first source and from at least one second source, and generating from these different clock information items a span of temporal coherence.

Also advantageously, the clock information items recovered by the digital television decoder are hierarchized particularly according to a previously established order, in order for example to define an internal reference clock of the considered digital television decoder.

The invention essentially relates to a method of determining an unusual behavior of an electronic apparatus, said electronic apparatus carrying out an operation requiring the use of an internal reference clock information item of said electronic apparatus, characterized in that it comprises the various steps consisting in:
comparing the internal reference clock information item with a span of temporal coherence of the electronic apparatus, said span of temporal coherence being determined on the basis of various temporal information items stored within the electronic apparatus;
in the case of inconsistency between the internal reference clock information item and the span of temporal coherence, storing an information item relating to an unusual behaviour of said electronic apparatus.

Apart from the main characteristics that have been mentioned in the preceding paragraph, the method according to the invention may have one or more complementary characteristics among the following, considered individually or according to all technically possible combinations:
the method comprises the additional step consisting in conditioning the storing of the information item relative to the unusual behaviour of the electronic apparatus on the observation of at least one of the following conditions in a limited time interval related to the carrying out of the operation requiring the use of the internal reference clock:
a number of information sources, from which the temporal information items are acquired, accessible by the electronic apparatus, has varied;
an operation of connecting and/or disconnecting a cable connected to the electronic apparatus has been observed;
an operation of purchasing an audio and/or video content has been carried out through the intermediary of the electronic apparatus.
the method comprises the various steps consisting in:
to determine the span of temporal coherence,
acquiring from a first information source a first temporal information item able to be used as internal clock of said electronic apparatus;
acquiring from at least one following information source at least one following temporal information item, each following temporal information item being able to be used as internal clock of said electronic apparatus;
storing in a memory of the electronic apparatus the first temporal information item and each following temporal information item, all of the stored temporal information items constituting a time base of the electronic apparatus;
selecting among the different stored temporal information items an internal reference clock of the electronic apparatus.
the step of selecting the internal reference clock is carried out by associating a hierarchy level with each stored temporal information item, the internal reference clock being constituted of the stored temporal information item associated with the highest hierarchy level.
the hierarchy level is assigned, for each stored temporal information item, as a function of the information sources from where the considered temporal information item comes.
rules of association of the levels of hierarchy are stored in a memory of the electronic apparatus prior to the acquisition of the temporal information items.
the method comprises the additional step consisting in replacing a stored temporal information item by a more recent temporal information item coming from the same information source as said stored temporal information item.

The present invention also relates to an electronic apparatus, particularly a digital television decoder, able to implement the method according to the invention.

### BRIEF DESCRIPTION OF DRAWINGS

The figures are only given for information purposes and in no way limit the invention. The figures show:

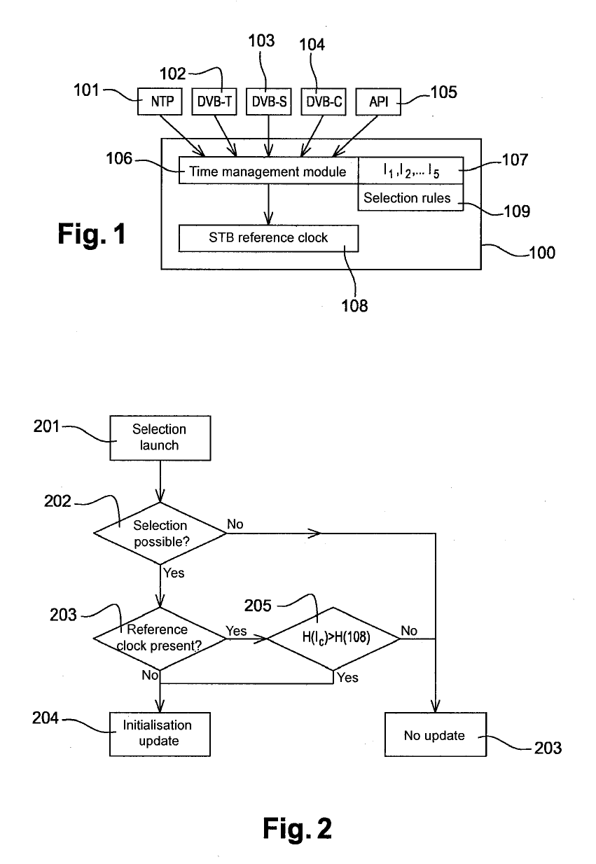

in FIG. 1, a schematic representation of the processing according to the invention, within a digital television decoder, of different available time sources;

in FIG. 2, a flow diagram illustrating an example of implementation of the method of generating a time base within a digital television decoder;

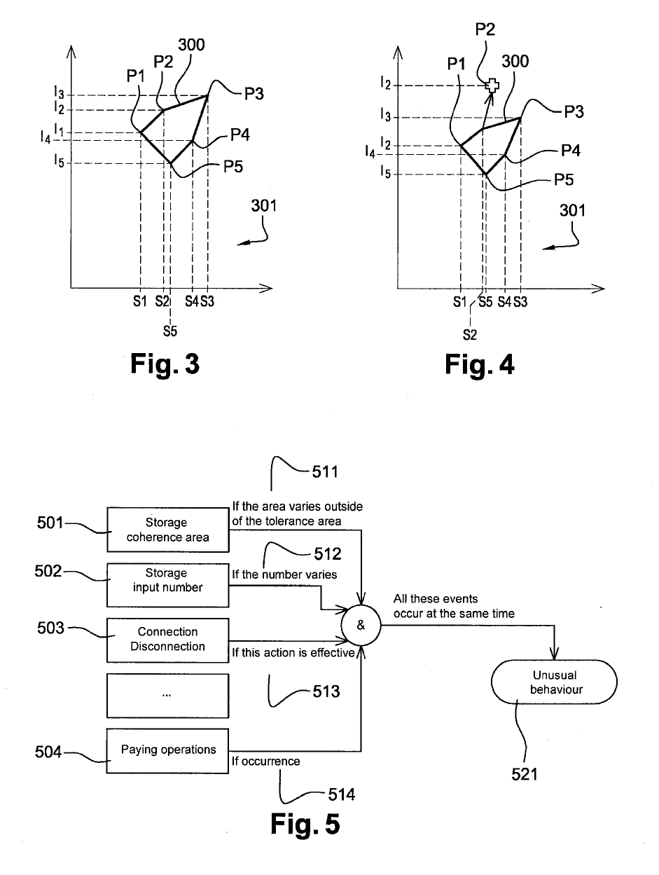

in FIG. 3, a schematic representation of a curve, forming a span of temporal coherence, illustrating the taking into account of different time sources within a digital television decoder;

in FIG. 4, a schematic representation of a temporal information item inconsistent in comparison with the coherence span of FIG. 3;

in FIG. 5, a diagram illustrating an example of application of the implementation of the method according to the invention of generation of a time base.

### DETAILED DESCRIPTION OF AT LEAST ONE EMBODIMENT OF THE INVENTION

Unless otherwise specified, a same element appearing in different figures has a single reference.

The invention is more particularly described within the context of digital television decoders, without the scope of the invention being restricted to this example of application.

FIG. 1 represents a digital television decoder 100 able to implement the method according to the invention. The decoder 100, to be able to implement the method according to the invention, is able to receive a flux of signals from at least one first source of signals and at least one second source of signals. Thus, in the example represented, the decoder 100 is able to receive signals from:
a first source 101 constituted of a remote server; this is then known as NTP (Network Time Protocol) source; the NTP source may be, in a conventional manner, of secure or basic type;
a second source 102 constituted of terrestrial broadcasting means, known under the acronym DVB-T (Digital Video Broadcasting Terrestrial);
a third source 103 constituted of satellite emission means, known under the acronym DVB-S (Digital Video Broadcasting Satellite);
a fourth source 104 constituted of cable emission means, known under the acronym DVB-C (Digital Video Broadcasting Cable);
a fifth source 105 constituted of emission means using the Internet network and portals using API.

In practice, any decoder able to receive a clock information item from at least one separate first source and a second source, chosen from among the sources that have been cited or others, is able to implement the method according to the invention.

In the decoder 100, for the implementation of the method according to the invention, the use of an internal clock management module 106 is proposed. The module 106 is able to identify in the signals received by different sources 101 to 105 clock information items, or temporal information items, li-i corresponding to an index identifying the source of the clock information item—specific to each of the sources considered. In fact, in practice, a difference which can extend up to several minutes may be observed between the different clock information items received from the different sources. According to the invention, the module 106 provides for the storing of all of these clock information items in a data storage module 107. All of the clock information items li thereby stored constitute a time base of the decoder 100.

Advantageously, once a temporal information item li is stored in the data storage module 107, it may be replaced by a following temporal information item received from the same source as the source having supplied said considered information.

According to the invention, the decoder selects an internal reference clock 108 from among the stored temporal information items li. The internal reference clock is used for all the conventional operations requiring the use of a temporal information item within the decoder. The invention proposes the advantage of leaving the distributor of the decoder with liberty to define what stored temporal information item will be used as internal reference clock. The choice of the internal reference clock among the different stored clock information items is made according to operating rules stored beforehand in a programme memory 109 of the time management module 106.

Thus, in an advantageous example, it is possible to define a level of hierarchy between the different temporal information items li stored in the data memory 107, the hierarchy level being for example associated with the source supplying the considered temporal information item.

The selection of the internal reference clock 108 is then carried out in the manner described with reference to the flow diagram of FIG. 2.

In this operating example, in a first step 201, the selection of an internal reference clock 201 is launched.

In a following decision step 202, it is verified that the decoder 100 indeed authorises, at the considered instant, such an operation of selection of internal reference clock. To this end, it is provided for example to verify the availability of one of the temporal information items li in the memory 107, which is then a candidate temporal information item le, and optionally to verify the value of a parameter stored within the decoder, parameter of which the value may evolve by the sending, via the flux of usual signals, of a new value for the considered parameter.

If the decoder 100 does not authorise the operation of selecting an internal reference clock, or if no candidate clock information item le is available in the memory 107, then the operation of selecting said internal reference clock is stopped in a step 203, and no new internal reference clock 108 is stored.

Conversely, if the operation of selecting an internal reference clock is possible, in a following decision step 204, a verification is carried out consisting in determining whether an internal reference clock 108 is already stored within the decoder 100. If not, in a following step 204, the internal reference clock 108 is updated by means of the stored temporal information item li determined as available in step 202, by initializing said internal reference clock by means of the value associated with the stored temporal information item li determined as available in step 202.

If an internal reference clock 108 is effectively already stored within the decoder 100, after having been selected beforehand from among the temporal information items available in the memory 107, in a decision step 205, it is determined if the candidate temporal information item le needs to replace or not the internal reference clock 108.

To this end, it is advantageously provided in the invention to associate each temporal information item li, and thus the candidate temporal information item le and the reference clock 108, with a value H that is specific to each source supplying the reference temporal information items.

Thus, it is possible to define as selection rule stored in the memory 109, for example, that the temporal information items coming from a satellite flux have a higher hierarchical level than the temporal information items coming from a flux of signals transmitted by cable. The hierarchy of the sources capable of supplying a temporal information item is determined by the distributor of the decoder and is stored in the selection rules of the memory 109; this hierarchy may advantageously be modified during the lifetime of the decoder.

It is thus verified in step 205 if the hierarchy level H(lc) of the candidate temporal information item is greater than the hierarchy level H(108) of the internal reference clock 108 of the decoder 100. If it does not, the internal reference clock is maintained without assigning to it the value of the temporal information item le in observing step 203. If it does, the internal reference clock 108 is updated using the value of the candidate temporal information item le in observing step 204.

In the invention, by storing different temporal information items li in the memory 107 of the time management module 106, a time base is available within the decoder 100. This time base makes it possible to define a span of temporal coherence 300 which is illustrated in FIG. 3. In this figure, five points P1, P2, P3, P4 and P5 have been positioned on a graph, the x-axis of which corresponds to the source supplying one of the temporal information items li, and the y-axis of which correspond to the value of the temporal information items li. Thus, in the example represented, the points P1 to P5 correspond respectively to the temporal information items 11 to 15, and come from five separate sources, referenced respectively S1 to S5.

The span of temporal coherence 300 is constituted of a series of temporal values which are not inconsistent compared to the stored temporal information items li. It is defined here that a temporal information item is not inconsistent compared to the stored temporal information items li if the positioning of said not inconsistent temporal information item, as a function of the source with which it is associated, in the graph 301 is located in the polygon, or in the immediate proximity of the polygon, formed by the summits of the points P1 to P5. It is said that a positioning Pi of said not inconsistent temporal information item li, as a function of the source with which it is associated, in the graph 301 is located in the immediate proximity of the polygon if the considered temporal information item li has not undergone any variation greater than several minutes, typically three minutes compared to its previously stored value. Thus, in FIG. 4, it is considered that the point P2, which has undergone a significant movement compared to its usual positioning represented in FIG. 3, reveals an inconsistent temporal information item 12.

FIG. 5 illustrates an example of use of the time bases 20 generated by the method according to the invention, using the spans of temporal coherence that ensue therefrom.

Thus, in FIG. 5 has been represented a series of events capable of being observed within the decoder 100 and which are capable of revealing an unusual behaviour of the decoder 100.

A set of data relative to the decoder 100 has thus firstly been stored.

A first data 501 is constituted of the coherence span 300 as defined previously. An event 511 capable of being observed, associated with this data, resides in the presence of an inconsistent temporal information item 30 as defined previously.

A second data 502 is constituted of the storing of the number of active inputs on the television decoder 100, in other words the number of sources available to supply information items to the decoder in the form of a flux of signals. An event 512 capable of being observed, associated with this data, resides in a variation in the number of active inputs available.

A third data 503 is constituted of the storing of the number of operations of connecting or and/or of disconnecting a cable connected to the decoder 100, whether it is a power supply cable, and/or a video cable, and/or an Ethernet cable, and/or any cable capable of being connected to the decoder 100. An event 513 capable of being observed, associated with this data, resides in the observation of an operation of connecting and/or disconnecting at least one of the cables.

A fourth data 504 is constituted of the presence of paying operations carried out within the decoder 100, for example the purchase of VOD. An event 514 capable of being observed, associated with this data, resides in the effective observation of paying operations carried out by means of the decoder.

According to the invention, if the event 511 is observed as well as at least one of the other events, or in certain examples of implementation all of these mentioned events is observed in a related limited time interval—in other words in a time span of several minutes, typically twenty or so minutes—of an operation requiring the use of the internal reference clock 108 (for example the purchase of a VOD), then an unusual behaviour 521 of decoder 100 is recorded.

Such an unusual behaviour may moreover constitute an index of presumption with regard to a fraudulent use of the decoder, a suspicion as regards an intervention of the user on the internal reference clock of the decoder then being present.

1. Method of determining an unusual behavior of an electronic apparatus, said electronic apparatus to carry out an operation requiring the use of an item of information regarding an internal reference clock of said electronic apparatus, the method comprising:
comparing the internal reference clock information item with a span of temporal coherence of the electronic apparatus, said span of temporal coherence being determined on the basis of various temporal information items stored within the electronic apparatus;
in the case of inconsistency between the internal reference clock information item and the coherence span, storing an information item relating to an unusual behavior of said electronic apparatus.

2. The method according to claim 1, further comprising conditioning the storing of the information item relative to the unusual behavior of the electronic apparatus on the observation of at least one of the following conditions in a limited time interval related to the carrying out of the operation requiring the use of the internal reference clock:
a number of information sources, from which the temporal information items are acquired, accessible by the electronic apparatus, has varied;
an operation of connecting and/or disconnecting a cable connected to the electronic apparatus has been observed;
an operation of purchasing an audio and/or video content has been carried out through the intermediary of the electronic apparatus.

3. The method according to claim 1, further comprising:
in order to determine the span of temporal coherence,
acquiring from a first information source a first temporal information item able to be used as internal clock of said electronic apparatus;
acquiring from at least one following information source at least one following temporal information item, each following temporal information item being able to be used as internal clock of said electronic apparatus;
storing in a memory of the electronic apparatus the first temporal information item and each following temporal information item, all of the stored temporal information items constituting a time base of the electronic apparatus;
selecting among the different stored temporal information items an internal reference clock of the electronic apparatus.

4. The method according to claim 3, wherein selecting the internal reference clock is carried out by associating a hierarchy level with each stored temporal information item, the internal reference clock being constituted of the stored temporal information item associated with the highest hierarchy level.

5. The method according to claim 4, wherein the hierarchy level is assigned, for each stored temporal information item, as a function of the information sources from where the considered temporal information item comes.

6. The method according to claim 4, wherein association rules of the levels of hierarchy are stored in a memory of the electronic apparatus prior to the acquisition of the temporal information items.

7. The method according to claim 3, further comprising replacing a stored temporal information item by a more recent temporal information item coming from the same information source as said stored temporal information item.

8. Electronic apparatus able to implement the method according to claim 1.

9. Digital television decoder able to implement the method according to claim 1.
